(19) United States
(12) Patent Application Publication
(10) Pub. No.: US 2008/0190236 A1
(43) Pub. Date: Aug. 14, 2008

(54) Motorcycle handlebar assembly with solid construction and tie-down system

(76) Inventor: Laron Taylor, Redding, CA (US)

Correspondence Address: THOMPSON & THOMPSON, P.A., P.O BOX 166, SCANDIA, KS, 66966, US

(21) Appl. No.: 11/705,898

(22) Filed: Feb. 13, 2007

(51) Int. Cl. B62K 21/12

(52) U.S. Cl. 74/551.8

(57) ABSTRACT

A motorcycle handlebar assembly provides attachment points for securing a motorcycle in a stable, upright position. The handlebar assembly includes first and second solid handlebars having respective first ends clamped to clamp structures on the fork assembly of the motorcycle, and respective second ends located at outer ends of the handlebars relative to a centerline of the motorcycle. The second ends each have an attachment opening that extends therethrough for receiving a hook-type end of a tie-down strap. The attachment opening is a diametrical bore through an enlarged head of the solid handlebar with bevels formed at each end of the diametrical bore. The solid handlebars are each machined in a single piece from a metal billet to enhance the strength and performance of the handlebar assembly. A circumferential groove can be formed in an external surface of each handlebar to interconnect with an element of the respective clamp structures.

### BACKGROUND OF THE INVENTION

1. Field of the Invention

The present invention relates generally to motorcycle handlebar assemblies and, in particular, to motorcycle handlebar assemblies that can be used with a tie-down system to secure motorcycles in an upright position for transport.

2. Description of the Related Art

Motorcycles are often transported on trailers or in the back of pickups or the like. During transport, the motorcycle must be secured in an upright position to prevent the motorcycle from falling over and becoming damaged. Modern sport motorcycles are often quite heavy and expensive and can be severely damaged, both structurally and cosmetically, if they are allowed to fall over during transport. Furthermore, modern sport motorcycles typically have thin outer skins shaped for aerodynamic efficiencies. These outer body panels are fragile and cover all of the traditional places where one might put a tie down hook.

A number of tie-down systems are known in the prior art for securing motorcycles in an upright position. For example, U.S. Pat. No. 5,326,202 issued to Stubbs discloses a tie-down system for maintaining a motorcycle in an upright position during transport, which uses grip cuffs that fit over the rubber handlebar grips of the motorcycle. This tie-down system keeps the straps from rubbing on the fragile outer skin of the motorcycle, but causes other problems. For example, the cuffs tend to stretch the return cable on the motorcycle to the point of stripping the stop from the inner cable and thereby ruining the throttle mechanism. The cuffs also tend to apply too much stress on other parts of the throttle assembly, including the bearing surface between the rotating handgrip and the handlebar.

Other motorcycle tie-down systems are also known in the prior art. U.S. Pat. No. 5,529,448 issued to Kosma discloses an adjustable mount for securing a motorcycle to a transport vehicle, which uses right and left tubes that fit over the existing handlebars, and a telescopic frame that connects to the tubes and has strap holes at its ends for receiving tie-down strap hooks. U.S. Patent Publication No. 2003/0152436 of Trauthwein discloses a tie-down system for motorcycles, which has a support T-bar secured to the central portion of the steering area, handlebar stabilizing hooks, and tie-down eyelets for attaching tie-down straps. U.S. Pat. No. 6,715,972 issued to Jackson, Sr. and U.S. Pat. No. 6,705,811 issued to Selby disclose additional tie-down systems in which tie-down devices are secured over the handgrip portions of a motorcycle's handlebars.

Another existing motorcycle tie-down system for securing a motorcycle in an upright position is disclosed in U.S. Pat. No. 6,761,519 issued to Alderman. Alderman's tie-down system includes a D-ring style end piece that attaches to an open end of a hollow handlebar to provide an attachment point for a tie-down strap. The D-ring end piece is attached to the hollow handlebar using an expanding structure that provides a friction attachment to the inner surface of the handlebar. While this friction attachment might be useful for relatively lightweight motorcycles having hollow tubes bent into handlebars, it does not provide a viable solution for modern sport motorcycles that have solid handlebars and a heavier construction.

The motorcycle tie-down systems described above do not provide a suitable system for securing modern sport motorcycles having solid handlebars in an upright position. There is a need in the industry for an improved tie-down system suitable for use with motorcycles having solid handlebars.

### SUMMARY OF THE INVENTION

The present invention provides a motorcycle handlebar assembly that has attachment points at its outer ends for securing a motorcycle in a stable, upright position. The handlebar assembly includes first and second solid handlebars having respective first ends clamped to clamp structures on the fork assembly of the motorcycle, and respective second ends located at outer ends of the handlebars relative to a centerline of the motorcycle. The second ends each have an attachment opening that extends therethrough for receiving a hook-type end of a tie-down strap. The attachment opening is a diametrical bore through an enlarged head of the solid handlebar with bevels formed at each end of the diametrical bore. The solid handlebars are each machined in a single piece from a metal billet to enhance the strength and performance of the handlebar assembly. A circumferential groove can be formed in an external surface of each handlebar to interconnect with an element of the respective clamp structures.

According to a broad aspect, the present invention provides a motorcycle handlebar, comprising: a solid bar having a first end adapted to be attached to a clamp structure on a motorcycle, and a second end comprising an attachment opening extending therethrough, the attachment opening providing a stable attachment point for receiving a hook-type end of a tie-down strap.

According to another broad aspect, the present invention provides a motorcycle handlebar assembly, comprising: a clamp assembly adapted to be secured to a fork assembly on which a front wheel is mounted, the clamp assembly comprising first and second clamp structures; first and second solid handlebars having respective first ends clamped to the first and second clamp structures, and respective second ends located at outer ends of the handlebars relative to a centerline of a motorcycle; and the second ends each comprising an attachment opening extending therethrough, the attachment openings providing stable attachment points for receiving hook-type ends of tie-down straps.

According to another broad aspect, the present invention provides a tie-down system for motorcycles, comprising: first and second handlebars which are each formed of a solid metal billet, the handlebars having respective first end structures clamped to a clamp structure of a motorcycle, and respective second end structures located at outer ends of the handlebars relative to a centerline of the motorcycle, the second end structures each comprising an enlarged head with an attachment opening extending therethrough; and first and second tie-down strap assemblies with hook means for attaching to the attachment openings to maintain a motorcycle in a stable upright position.

Numerous other objects and features of the present invention will be apparent to those skilled in this art from the following description wherein there is shown and described an exemplary embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective view of a motorcycle anchored to a trailer using a solid handlebar tie-down system according to the present invention.

FIG. 2 is a perspective view of a solid motorcycle handlebar according to the present invention.

FIG. 3 is a plan view of the solid motorcycle handlebar shown in FIG. 2.

FIG. 4 is a detail view, in partial cross section, of an end of the solid motorcycle handlebar.

FIG. 5 is a plan view of a motorcycle handlebar assembly with the solid motorcycle handlebars attached to respective clamp structures.

FIG. 6 illustrates a solid motorcycle handlebar according to the present invention with a hook structure of a tie-down strap attached to an attachment opening formed in an end of the handlebar.

### DETAILED DESCRIPTION OF THE INVENTION

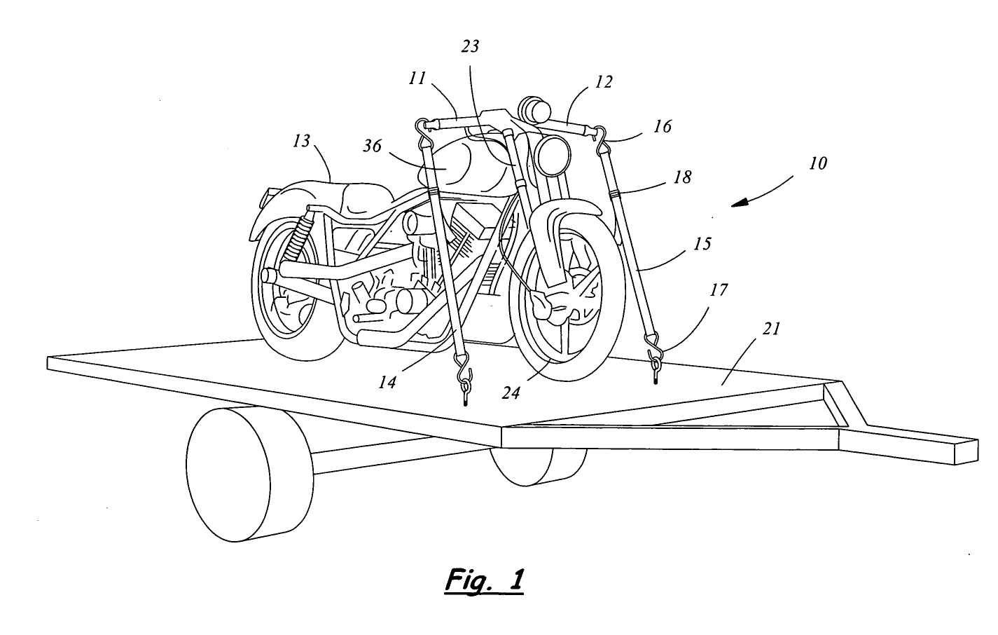

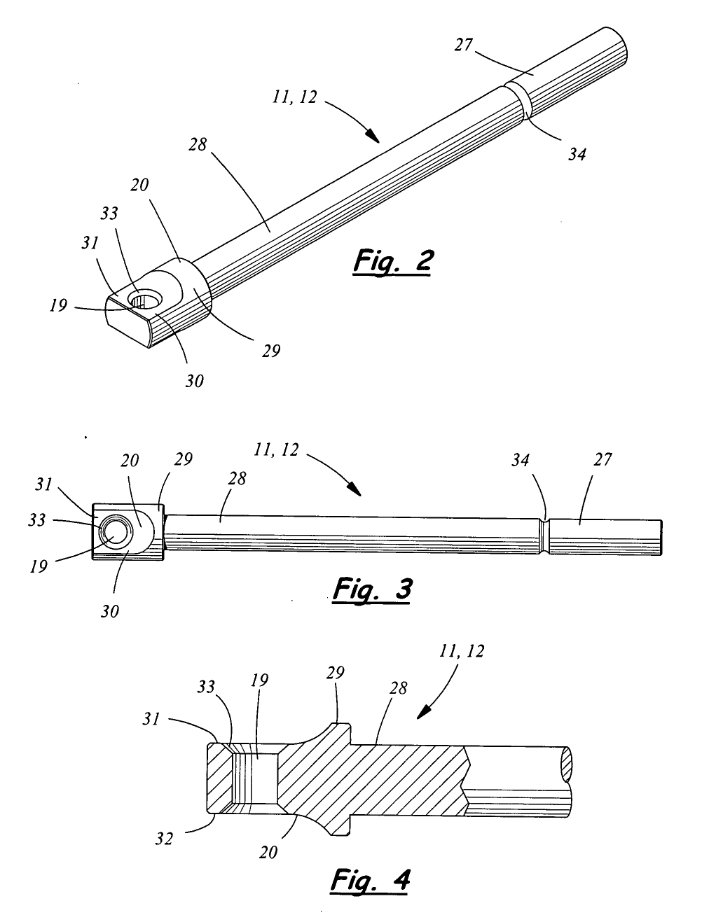

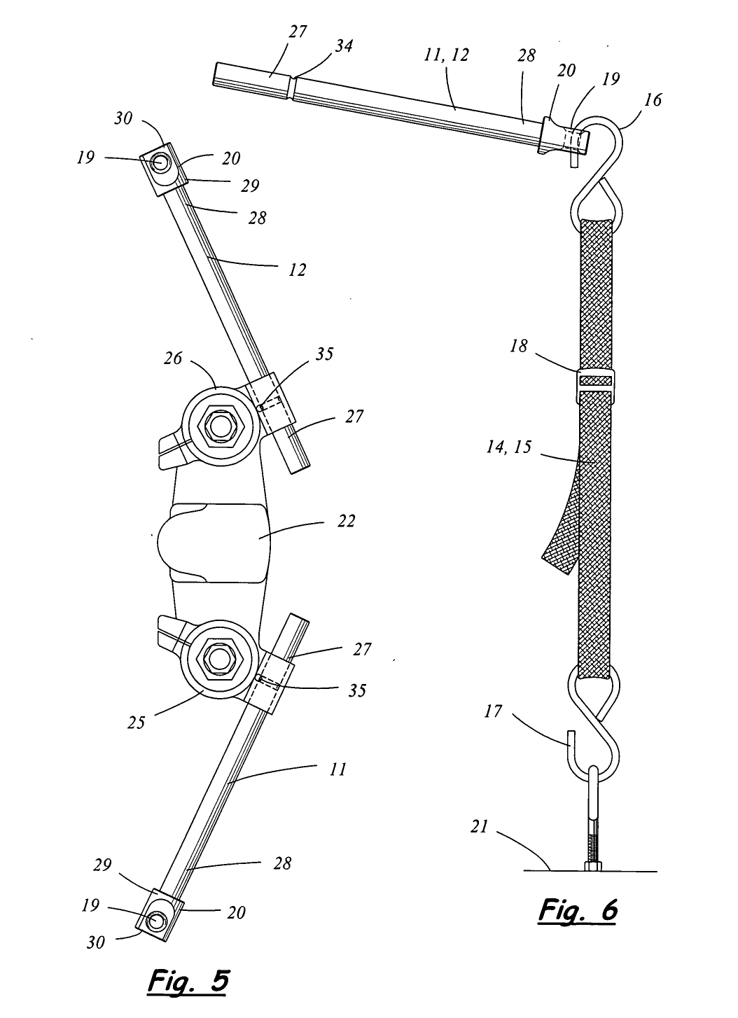

A motorcycle handlebar assembly and tie-down system according to the present invention will now be explained in detail with reference to FIGS. 1 to 6 of the accompanying drawings.

The tie-down system 10 of the present invention is shown in FIG. 1. The tie-down system 10 includes first and second handlebars 11, 12 on the right and left sides of a motorcycle 13, and first and second tie-down strap assemblies 14, 15. The tie-down strap assemblies 14, 15 each have hook structures 16, 17 at their ends and an adjustment mechanism 18 to adjust the length of the strap assemblies.

The hook structures 16 at the upper ends of the tie-down strap assemblies 14, 15 are received in attachment openings 19 formed in the outer ends 20 of the handlebars 11, 12. The hook structures 17 at the lower ends of the tie-down strap assemblies 14, 15 are anchored to a trailer bed 21 or pickup box or other transport vehicle. By inserting the hook structures 16 into the attachment openings 19 in the outer ends 20 of the handlebars 11, 12 and tightening the adjustment mechanism 18 of the tie-down strap assemblies 14, 15, the tie-down system 10 can be used to secure the motorcycle 13 in a stable, upright position on the trailer bed 21 or pickup box or other transport vehicle.

The motorcycle handlebar assembly includes a clamp assembly 22 secured to a fork assembly 23 of the motorcycle 13 on which a front wheel 24 is mounted. The clamp assembly 22 includes right and left clamp structures 25, 26 positioned on respective right and left sides of the centerline of the motorcycle 13 (i.e., right and left of the pivot axis of the fork assembly 23). The clamp structures 25, 26 can be conventional triple clamp assemblies or other suitable clamp structures known in the art.

The handlebar assembly also includes the first and second handlebars 11, 12. The handlebars 11, 12 have first ends 27 clamped in the right and left clamp structures 25, 26, and second ends 20 located at the outer ends of the handlebars relative to a centerline of the motorcycle 13. The handlebars 11, 12 are solid bars formed of a solid metal billet, such as aluminum, steel, or titanium. Because the handlebars 11, 12 are formed of a solid billet, they do not have a tubular construction or a hollow interior. The solid construction of the handlebars 11, 12 provides a much stronger construction to meet the demands of modern sport motorcycles.

The handlebars 11, 12 have handgrip areas 28 that can be covered by a rubber handgrip or throttle assembly in a known manner. The throttle assembly will fit over the right-side handlebar 11 and will use the outer surface of the handgrip area 28 of the handlebar 11 as a bearing surface for rotating the handgrip of the throttle assembly.

The second ends 20 of the handlebars 11, 12 have enlarged heads that define an outer extent of the handgrip areas 28 for each handlebar 11, 12. The enlarged heads each include a first shoulder portion 29 having a larger diameter than the handgrip area 28, and a second portion 30 in which the attachment opening 19 is formed. The second portion 30 has two diametrically opposed flat surfaces 31, 32 with the attachment opening 19 comprising a diametrical bore extending through the enlarged head between the two flat surfaces 31, 32. A distance between the two flat surfaces 31, 32 is less than the diameter of the first shoulder portion 29. In a preferred embodiment, the handlebars 11, 12 are machined in a single integral piece from a solid metal billet.

A bevel 33 is formed at each end of the diametrical bore 19 to facilitate insertion of a hook structure 16 of a tie-down strap 14, 15. In a preferred embodiment, the bevel 33 is angled at approximately 41 degrees relative to a centerline of the bore 19, and the bore 19 has a diameter of approximately 0.575 inch. These dimensions have been determined to be well suited for accommodating the hook structures of typical S-shaped hooks used with tie-down straps.

Each of the handlebars 11, 12 has a circumferential groove 34 formed in an external surface near the first end 27. The grooves 34 provide a means for interconnecting with an element 35 of the first and second clamp structures 25, 26 to prevent longitudinal movement of the handlebars 11, 12 within the clamp structures 25, 26. The interconnecting element 35 can be a threaded bolt or pin inserted through an opening in each of the clamp structures 25, 26 and fit into the groove 34 to prevent longitudinal movement of the handlebars 11, 12, while allowing rotational movement of the handlebars 11, 12 about their longitudinal axes upon loosening the clamp structures 25, 26.

The tie-down system 10 of the present invention prevents damage to motorcycle body panels 36 by moving the attachment points 19 outside of the main body area. By moving the attachment points 19 as far from the centerline of the motorcycle 13 as possible (i.e., to the outer tips of the handlebars 11, 12), leverage is increased allowing lighter tension in the straps 14, 15. This helps maintain the motorcycle 13 in a stable, upright position. The invention also helps prevent damage caused by over tightening of improperly positioned tie-down straps (e.g., bending of handlebars, forks and frame). The tie-down system 10 of the present invention also avoids stretching or damaging the throttle return cables on push-pull type throttles, which can be a problem with cuff-type tie-down systems.

The solid handlebar construction and attachment openings 19 in the ends 20 of the solid handlebars 11, 12 as described herein provide an extremely strong tie-down system suitable for use with modern sport motorcycles to achieve the objectives of the present invention.

The enlarged heads 20 of the handlebars 11, 12 can be machined in a variety of different aesthetic shapes to suit individual tastes, such as square, octagonal, round or truncated shapes.

While the invention has been specifically described in connection with specific embodiments thereof, it is to be understood that this is by way of illustration and not of limitation, and the scope of the appended claims should be construed as broadly as the prior art will permit.

What is claimed is:

1. A motorcycle handlebar, comprising:
a solid bar having a first end adapted to be attached to a clamp structure on a motorcycle, and a second end; and
said second end comprising an attachment opening extending therethrough, said attachment opening providing a stable attachment point for receiving a hook-type end of a tie-down strap.

2. The motorcycle handlebar according to claim 1, further comprising a circumferential groove formed in said solid bar near said first end, said circumferential groove providing a means for interconnecting with a clamp structure on a motorcycle for preventing longitudinal movement of the handlebar.

3. The motorcycle handlebar according to claim 1, wherein said second end comprises an enlarged head, and said attachment opening comprises a diametrical bore through said enlarged head.

4. The motorcycle handlebar according to claim 3, further comprising a bevel formed at each end of said diametrical bore.

5. The motorcycle handlebar according to claim 4, wherein said bore has a diameter of approximately 0.575 inch, and said bevel is angled at approximately 41 degrees relative to a centerline of said bore.

6. The motorcycle handlebar according to claim 1, wherein said second end comprises an enlarged head which is integral with said solid bar.

7. The motorcycle handlebar according to claim 1, wherein said second end comprises an enlarged head having a first shoulder portion adjacent to said second end of the solid bar, and a second portion in which said attachment opening is formed, said second portion comprising two diametrically opposed flat surfaces with said attachment opening extending between said flat surfaces.

8. The motorcycle handlebar according to claim 7, wherein a distance between said two flat surfaces is less than a diameter of said first shoulder portion.

9. The motorcycle handlebar according to claim 1, wherein said second end comprises an enlarged head, and said solid bar is machined in a single integral piece from a solid metal billet.

10. The motorcycle handlebar according to claim 1, wherein said solid bar is made in a single integral piece from a solid piece of aluminum.

11. The motorcycle handlebar according to claim 1, wherein said solid bar is made in a single integral piece from a solid piece of steel.

12. The motorcycle handlebar according to claim 1, wherein said solid bar is made in a single integral piece from a solid piece of titanium.

13. A motorcycle handlebar assembly, comprising:
a clamp assembly adapted to be secured to a fork assembly on which a front wheel is mounted, said clamp assembly comprising first and second clamp structures;
first and second solid handlebars having respective first ends clamped to said first and second clamp structures, and respective second ends located at outer ends of the handlebars relative to a centerline of a motorcycle; and
said second ends each comprising an attachment opening extending therethrough, said attachment openings providing stable attachment points for receiving hook-type ends of tie-down straps.

14. The motorcycle handlebar assembly according to claim 13, further comprising a circumferential groove formed in each of said first and second solid handlebars near said first ends thereof, said circumferential grooves providing means for interconnecting with an element of said first and second clamp structures for preventing longitudinal movement of the handlebar.

15. The motorcycle handlebar assembly according to claim 14, wherein said second ends comprise enlarged heads, and wherein said attachment openings comprise diametrical bores that extend through said enlarged heads.

16. The motorcycle handlebar assembly according to claim 15, wherein said enlarged heads each comprises two diametrically opposed flat surfaces with said attachment opening extending between said flat surfaces.

17. The motorcycle handlebar assembly according to claim 15, wherein said diametrical bores comprise beveled openings at each end.

18. The motorcycle handlebar assembly according to claim 13, wherein said first and second solid handlebars each comprises an enlarged head formed integral with a solid bar, and said attachment openings are formed in said enlarged heads.

19. The motorcycle handlebar assembly according to claim 13, wherein said first and second solid handlebars are each machined in a single integral piece from a solid metal billet.

20. A tie-down system for motorcycles, comprising:
first and second handlebars which are each formed of a solid metal billet, said handlebars having respective first end structures clamped to a clamp structure of a motorcycle, and respective second end structures located at outer ends of the handlebars relative to a centerline of the motorcycle, said second end structures each comprising an enlarged head with an attachment opening extending therethrough; and
first and second tie-down strap assemblies with hook means for attaching to said attachment openings to maintain a motorcycle in a stable upright position.
